(19) United States
(12) Patent Application Publication
(10) Pub. No.: US 2012/0027426 A1
(43) Pub. Date: Feb. 2, 2012

(54) IMAGE FORMING APPARATUS AND IMAGE FORMING METHOD

(76) Inventor: Masaaki MARUTA, Osaka (JP)

(21) Appl. No.: 13/190,582

(22) Filed: Jul. 26, 2011

(30) Foreign Application Priority Data
Jul. 27, 2010 (JP) P2010-168093

(51) Int. Cl. G03G 15/00

(52) U.S. Cl. 399/16; 399/394

(57) ABSTRACT

An image forming apparatus including an image forming unit forming an image on a recording paper, a registration roller transporting the recording paper to the image forming unit, a post-registration roller detection unit provided at a down stream side of the registration roller in a direction in which the recording paper is transported, the post-registration roller detection unit detecting the recording paper transported by the registration roller and a control unit adjusting a timing in which the image forming unit forms the image on the recording paper based on a timing at which the post-registration roller detection unit detects the recording paper.

### BACKGROUND OF THE INVENTION

The present application claims priority on Japanese Patent Application No. 2010-168093, filed Jul. 27, 2010, the content of which is incorporated herein by reference.

1. Field of the Invention

The present invention relates to an image forming apparatus and an image forming method.

2. Description of the Related Art

Conventionally, according to a recording paper transportation mechanism of an image forming apparatus such as a multi functional peripheral or a printer and the like, a registration roller is used to adjust the timing at which an image is written out. The registration roller is also used to correct a skewing. Normally, a recording paper, which was set inside a paper feeding cassette, is sent to a registration roller via an intermediate roller. When the intermediate roller sends the recording paper to a halting registration roller, a positioning of the tip of the recording paper is conducted there. In addition, a deflection in the upper-lower direction is formed. Thereafter, the registration roller and the intermediate roller are driven. Thus, the recording paper is transported to an image forming unit. A driving unit of a roller may be configured in many ways. For example, a drive motor may be attached individually to a roller. In another configuration, a drive motor and a clutch may be used in combination. For instance, according to a printer, based on considerations on cost, one drive motor drives each of the rollers, while a clutch controls the rotations.

However, in recent years, the speed of image formation has increased. Accordingly, the speed at which recording paper is transported is also increasing. As a result, a lagging in the response in the linking and releasing of the clutch of the intermediate roller has triggered a problem in which the amount of deflection of the recording paper cannot be controlled to be a predetermined amount at the registration roller. Consequently, a position of an image copied on a recording paper might be displaced.

Therefore, an image forming apparatus is suggested such that the rotational speed of the intermediate roller is controlled so that the dispersion in the switchover time of the clutch of the intermediate roller is absorbed. As a result, the amount of paper sent out by the intermediate roller is adjusted to be a predetermined amount. In this way, the amount of deflection at the registration roller is maintained to be constant.

However, since there is a dispersion in the response time of the registration roller, the amount of time it takes for a recording paper to reach an intermediate copying belt or a photoreceptive drum, located in a down stream side in the direction in which the recording paper is transported, also varies as well. As a result, the position at which an image is copied to a recording paper deviates.

### SUMMARY OF THE INVENTION

In order to achieve the above object, the present invention employs the following.

Namely, an image forming apparatus according to an aspect of the present invention includes an image forming unit forming an image on a recording paper, a registration roller transporting the recording paper to the image forming unit, a post-registration roller detection unit provided at a down stream side of the registration roller in a direction in which the recording paper is transported, the post-registration roller detection unit detecting the recording paper transported by the registration roller and a control unit adjusting a timing in which the image forming unit forms the image on the recording paper based on a timing at which the post-registration roller detection unit detects the recording paper.

In addition, an image forming method according to an aspect of the present invention includes a registration step transporting a recording paper and registering with a registration roller, a post-registration roller detection step detecting the recording paper, transported by the registration roller, at a down stream side of the registration roller in a direction in which the recording paper is transported and a control step adjusting a timing at which an image is formed on the recording paper based on a timing at which the recording paper is detected in the post-registration roller detection step.

Effect of the Invention

According to the present invention, the timing at which an image is formed on a recording paper by the image formation unit is adjusted based on a timing at which a post-registration roller detection unit detects the recording paper.

In this way, according to the present invention, the timing at which an image is formed may be synchronized based on the timing at which a recording paper, already transported by the registration roller, is detected. As a result, it is possible to prevent a condition in which the position of the image on the recording paper is deviated due to a lag in the response time of the registration roller.

### BRIEF DESCRIPTION OF THE DRAWINGS

FIG. 1 is a skeletal configurative diagram of a printer A according to an embodiment of the present invention.

FIG. 2 is a diagram showing a paper transporting mechanism of a printer A according to an embodiment of the present invention.

FIG. 3 is a diagram showing a condition in which a paper is transported in a printer A according to an embodiment of the present invention.

FIG. 4 is a diagram showing another condition in which a paper is transported in a printer A according to an embodiment of the present invention.

FIG. 5 is a diagram showing another condition in which a paper is transported in a printer A according to an embodiment of the present invention.

FIG. 6 is a diagram showing another condition in which a paper is transported in a printer A according to an embodiment of the present invention.

FIG. 7 is a flowchart showing an operation of a printer A according to the above embodiment.

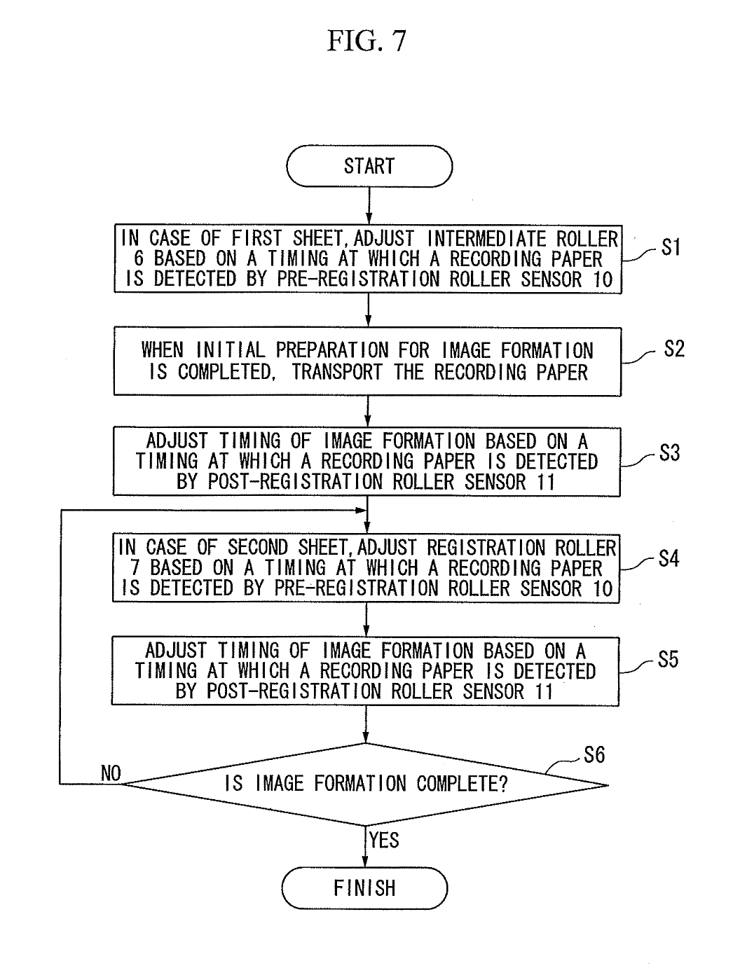

### DETAILED DESCRIPTION OF THE PREFERRED EMBODIMENTS

Hereinafter, an embodiment of the present invention is described with reference to the attached diagrams.

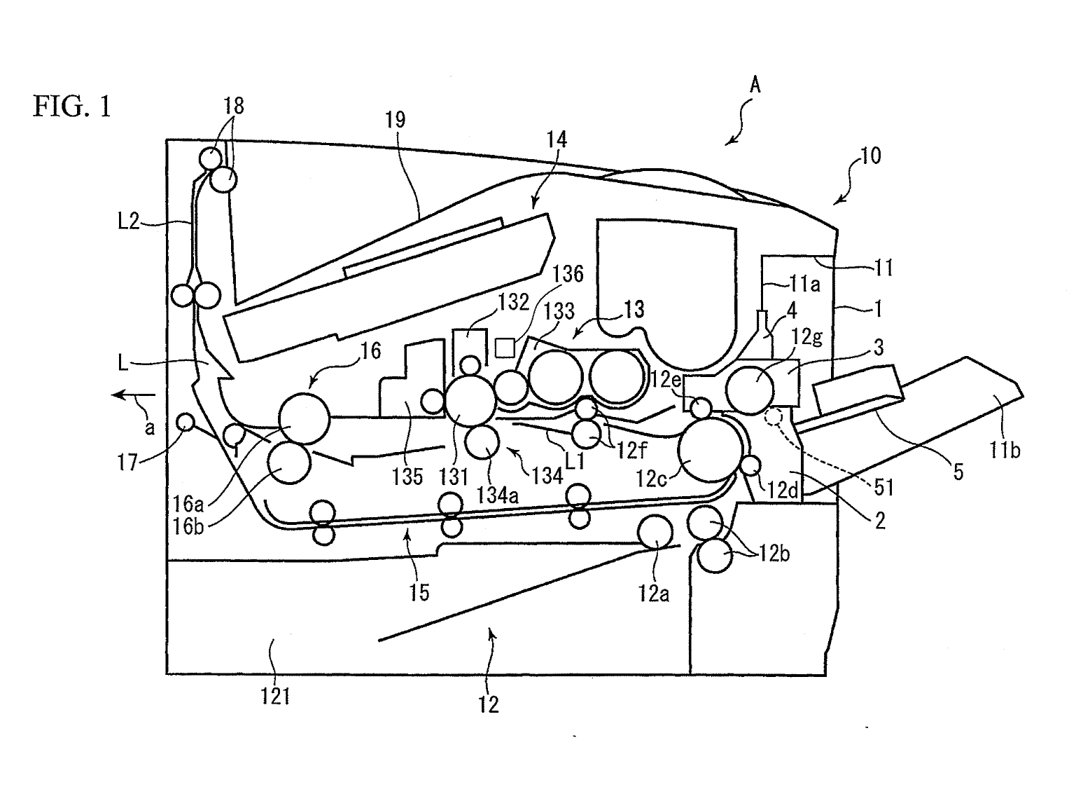

As shown in FIG. 1, a printer (image forming apparatus) A according to the present embodiment is connected to a plurality of client computers via a local area network. When a printing instruction is received from a client computer, an image is formed on a recording medium (hereinafter referred to as a recording paper 200) based on an electrophotographic method. As shown in FIG. 1, the printer A is configured so that a recording paper 200 is provided by a pick up roller 12a of a paper feeding unit 12 and paper feeding rollers 12b. A timing of a tip of a recording paper 200, which was transported by an intermediate roller 12e, is adjusted at the registration roller 12f. Thereafter, the recording paper 200 is sent to an image formation unit 13.

Meanwhile, at the image formation unit 13, an electrostatic latent image is formed on a peripheral surface of a photoreceptor drum 131, as described later. Then, a toner image is formed based on this electrostatic latent image.

The photoreceptor drum 131 is cylindrical. The photoreceptor drum 131 is placed so as to be elongated in a depth direction seen from a front surface of the printer A. The photoreceptor drum 131 is rotated by a drive unit (not diagrammed) such as a motor. The speed of rotation of the drive unit can be adjusted. The photoreceptor drum 131 is rotated in the direction of the peripheral surface when an image is formed.

A charging unit 132 is placed opposite to the photoreceptor drum 131. The charging unit 132 evenly charges a peripheral surface of the photoreceptor drum 131 to a positive or a negative polarity.

The laser scanning unit 136 irradiates a laser beam to a peripheral surface of a charged photoreceptor drum 131. In this way, the laser scanning unit 136 creates an electrostatic latent image on a surface of the photoreceptor drum 131 according to an image data.

A development unit 133 provides a toner to a peripheral surface of the photoreceptor drum 131. In this way, the development unit 133 develops a toner image based on the electrostatic latent image on the peripheral surface of the photoreceptor drum 131.

A cleaning unit 135 removes toner remaining on the photoreceptor drum 131 after a toner image is transferred to a recording paper 200 from the photoreceptor drum 131, and after a toner is transferred to a recording paper 200 by a transfer roller 134a, described later.

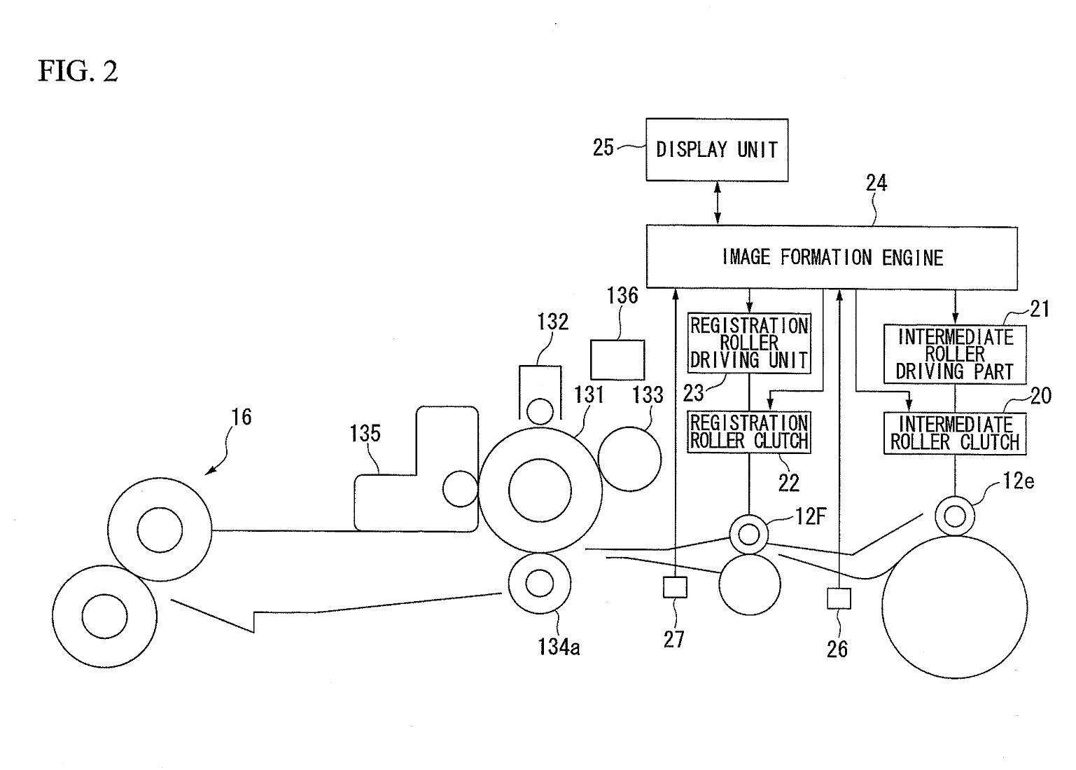

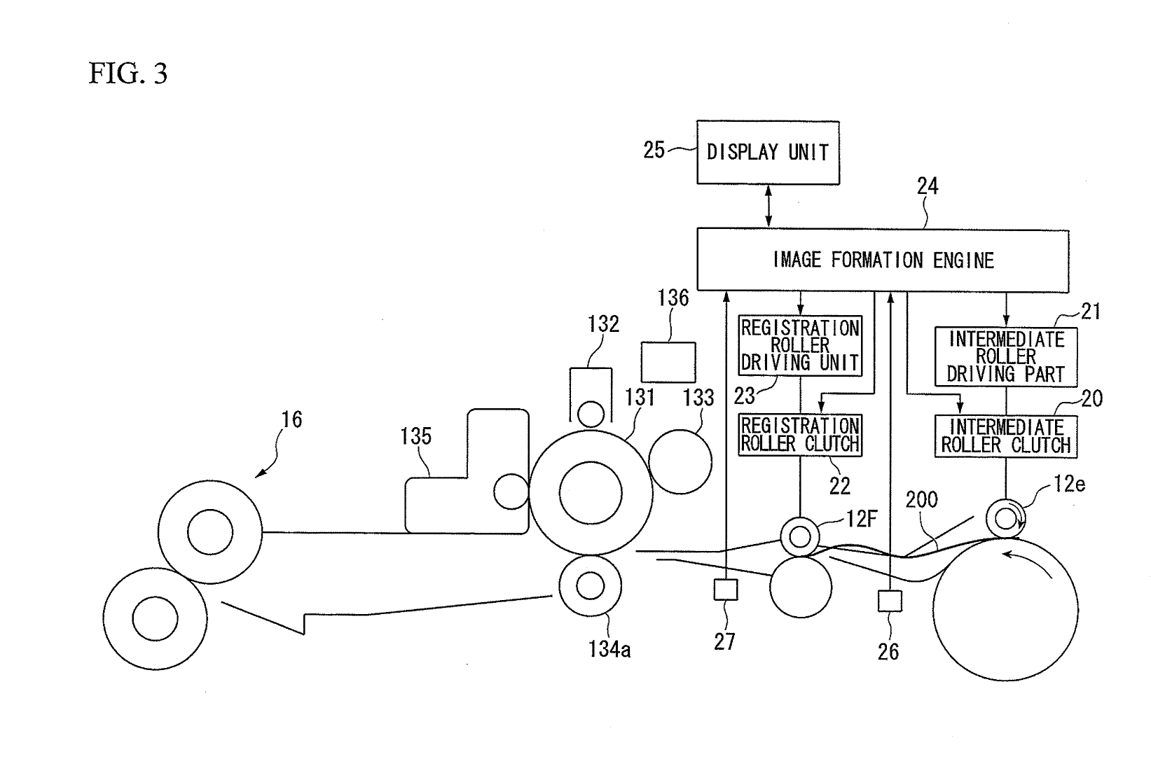

Next, a paper transportation mechanism is described with reference to FIG. 2. The intermediate roller 12e is driven and rotated by an intermediate roller driving unit 21 connected via an intermediate roller clutch 20. The intermediate roller 12e is provided at an upper stream side of the registration roller 12f with respect to a direction in which the recording paper 200 is transported. The intermediate roller 12e transports a recording paper 200, transported from a paper feeding cassette which is not diagrammed, to the registration roller 12f. The intermediate roller 12e creates a deflection on the recording paper 200, as shown in FIG. 3, between the intermediate roller 12e and the registration roller 12f.

The registration roller 12f is driven and rotated by a registration roller driving unit 23, which is connected via the registration roller clutch 22. The registration roller 12f transports a recording paper 200, transported from the intermediate roller 12e, to the transfer roller 134a.

The transfer roller 134a is placed opposite to the photoreceptor drum 131. The transfer roller 134a is driven and rotated by a driving source such as a motor and the like. In this way, a recording paper 200 is sandwiched between the transfer roller 134a and the photoreceptor drum 131. The transfer roller 134a transfers a toner image, formed upon the photoreceptor drum 131, on a recording paper 200 by applying a transfer current. After this transfer, the recording paper 200 is transported to fixing rollers 16.

The fixing rollers 16 include a heating roller 16a and a pressure roller 16b. A heater is included inside the heating roller 16a. The pressure roller 16b is welded to the heating roller 16a. The fixing roller 16 heats the recording paper 200 and applies pressure to the recording paper 200 by transporting and sandwiching the recording paper 200, to which a toner image has been copied, with two rollers 16a and 16b. In this way, the fixing rollers 16 fix a toner image on the recording paper 200. The recording paper 200, to which a toner image has been fixed by the fixing rollers 16, is transported to paper ejection rollers 18 which are not diagramed.

The pre-registration roller sensor 26 included in the pre-registration roller detection unit is placed between the intermediate roller 12e and the registration roller 12f. In other words, the pre-registration roller sensor 26 is placed in front of the registration roller 12f (at an upper stream side) in a direction in which the recording paper 200 is transported. The pre-registration roller sensor 26 emits light towards a transportation path. The pre-registration roller sensor 26 detects a recording paper 200 based on a reflected light. Further, the pre-registration roller 26 outputs the detection result to an image formation engine 24 as a detection signal.

The post-registration roller sensor 27 included in the post-registration roller detection unit is placed in the rear of the registration roller 12f (at a down stream side) in a direction in which the recording paper 200 is transported. The post-registration roller sensor 27 emits light towards a transportation path. The post-registration roller sensor 27 detects a recording paper 200 based on a reflected light. Further, the post-registration roller 27 outputs the detection result to an image formation engine 24 as a detection signal.

Under the control of the image formation engine 24, the intermediate roller clutch 20 switches to a connected condition or a disconnected condition. Under the connected condition, a rotational driving force from the intermediate roller driving unit 21 can be transmitted to the intermediate roller 12e. Under the disconnected condition, the rotational driving force is not transmitted to the intermediate roller 12e.

The intermediate roller driving unit 21 is a driving source of a motor and the like. The intermediate roller driving unit 21 is connected to a roller axis of the intermediate roller 12e via the intermediate roller clutch 20. Under the control of the image formation engine 24, the intermediate roller driving unit 21 drives and rotates the intermediate roller 12e.

Under the control of the image formation engine 24, the registration roller clutch 22 switches to a connected condition or a disconnected condition. Under the connected condition, a rotational driving force from the registration roller driving unit 23 can be transmitted to the registration roller 12f. Under the disconnected condition, the rotational driving force is not transmitted to the registration roller 12f. Therefore, the registration roller clutch 22 can rotate the registration roller 12f or halt the rotation of the registration roller 12f while maintaining the condition in which the registration roller driving unit 23 is rotated.

The registration roller driving unit 23 is a driving source such as a motor. The registration roller driving unit 23 is connected to a roller axis of the registration roller 12f via a registration roller clutch 22. Under the control of the image formation engine 24, the registration roller driving unit 23 drives and rotates the registration roller 12f.

The display unit 25 is a liquid crystal monitor, for example. The display unit 25 displays various screens including an image and/or a letter based on a signal inputted by the image formation engine 24.

The image formation engine 24 includes a CPU (Central Processing Unit), a ROM (Read Only Memory), a RAM (Random Access Memory), and an interface circuit which performs an input and output of signals with each of the components described above. The image formation engine 24 controls the overall operation of the printer A based on a control program stored in the ROM. Incidentally, the control program stored in the ROM includes an image formation control program. The image formation engine 24 controls the timing at which an electrostatic latent image is formed on the photoreceptor drum 131 based on this image formation control program. Incidentally, the details of the operations performed by the image formation engine 24 are given below, with the operations of the printer A being described as an example.

Next, a paper supplying operation and a paper transporting operation of a printer A according to the present embodiment are described in detail with reference to FIGS. 3-6.

First, a user, who is trying to make a printout using the printer A, first operates a client computer (not diagrammed), and transmits a printing instruction to the printer A.

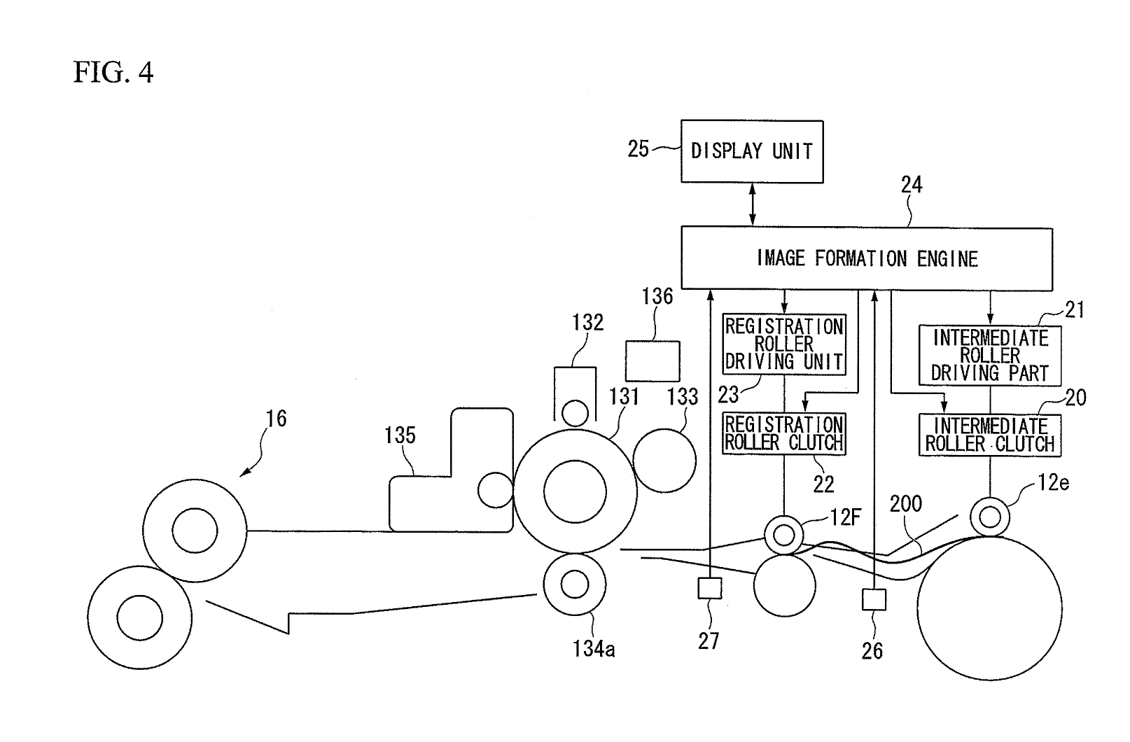

When the image formation engine 24 receives a printing instruction from a client computer, and when an image is formed on a first sheet, the deflection of a recording paper 200 is adjusted by adjusting a timing at which the intermediate roller 12e is halted based on a timing at which the recording paper 200 is detected by the pre-registration roller sensor 26, as shown in FIG. 3 (step S1). In other words, when an image is formed on a first sheet, the image formation engine 24 rotates the intermediate roller 12e by switching the condition of the intermediate roller clutch 20 from a disconnected condition to a connected condition. Thus, according to the image formation engine 24, a recording paper 200, transported from a paper feeding cassette (not diagrammed), is transported towards the registration roller 12f by the intermediate roller 12e. Incidentally, at this stage, the rotation of the registration roller 12f is halted. Further, when the pre-registration roller sensor 26 detects a first recording paper 200, and after a predetermined amount of time has passed, the image formation engine 24 switches the condition of the intermediate roller clutch 20 from a connected condition to a disconnected condition. Further, the image formation engine 24 halts the intermediate roller 12e. (FIG. 4) Incidentally, the “predetermined amount of time” refers to the period of time from the moment when the recording paper 200 passes through the pre-registration roller sensor 26 to the moment at which a predetermined deflection is formed under a condition in which the recording paper 200 is pressed against the registration roller 12f.

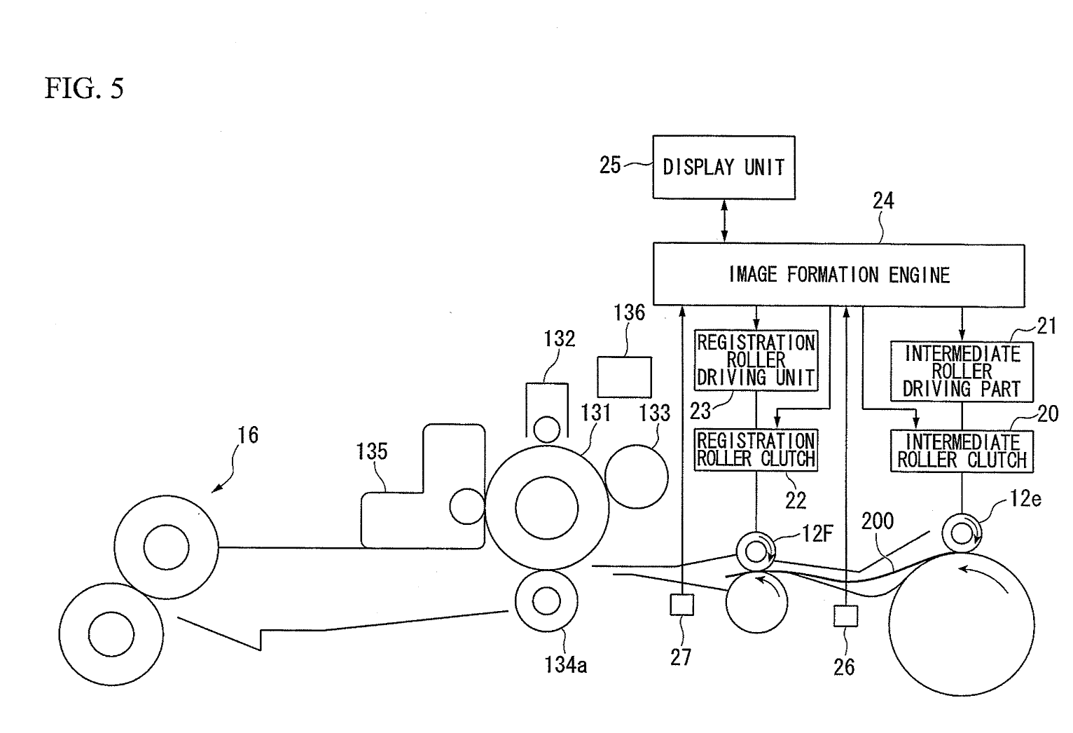

After step S1, the image formation engine 24 makes the intermediate roller 12e and the registration roller 12f wait under a condition in which the rotations are halted and under a condition in which the deflection is formed on the recording paper 200. During this time, the fixing roller 16 performs initial preparation for forming an image, such as heating. When the initial preparation for forming an image is completed, the condition of the intermediate roller clutch 20 is switched from a disconnected condition to a connected condition, as shown in FIG. 5. Thus, the intermediate roller 12e is rotated. At the same time, the condition of the registration roller clutch 22 is switched from a disconnected condition to a connected condition. Thus, the registration roller 12f is rotated. Further, the recording paper 200 is transported towards the photoreceptor drum 131 (step S2). In this way, while the initial preparation for forming an image is performed, the recording paper 200 is made to wait between the intermediate roller 12e and the registration roller 12f, instead of waiting at a paper feeding cassette. As a result, an image formation may be started immediately after the initial preparation has been completed.

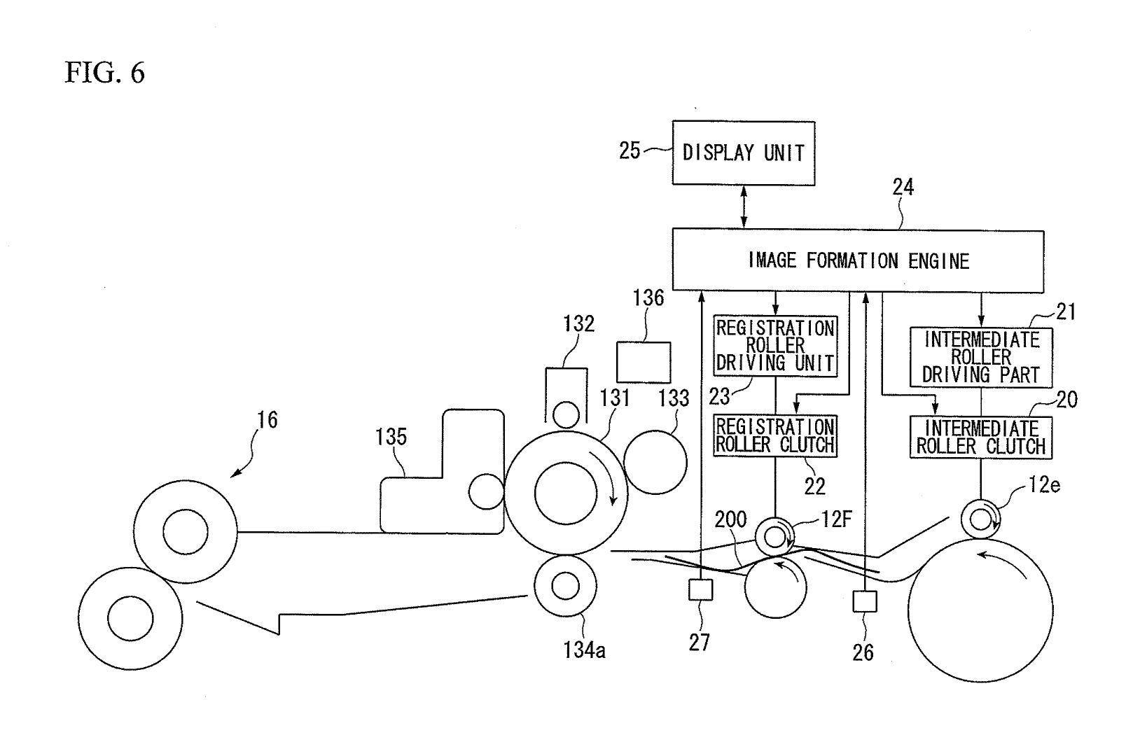

After step S2, when the recording paper 200, transported by the registration roller 12f, is detected by the post-registration roller sensor 27, the image formation engine 24 adjusts a timing at which an image is formed on a recording paper 200 based on a timing at which the post-registration roller sensor 27 detects this recording paper 200 (step S3). In other words, as shown in FIG. 6, the image formation engine 24 adjusts the timing at which an image is formed on a recording unit based on a timing at which the post-registration roller sensor 27 detects the recording unit, after the photoreceptor drum 131 rotates, the charging unit 132 evenly charges the surface of the photoreceptor drum 131, and an electrostatic latent image is formed by the laser scanning unit 136. In this way, it is possible to prevent the position of the image on the recording paper 200 from deviating.

When the image formation in step S3 is completed, the image formation engine 24 moves on to forming an image on a second sheet. When an image is formed on a second sheet or other subsequent sheets, the image formation engine 24 adjusts the deflection of the recording paper 200 by adjusting a timing at which the registration roller 12f is rotated based on a timing at which the recording paper 200 is detected by the pre-registration roller sensor 26 (step S4). In other words, when an image is formed on a second sheet or other subsequent sheets, the image formation engine 24 makes the condition of the intermediate roller clutch 20 a connected condition. Thus, the intermediate roller 12e continues to be rotated. At the same time, the image formation engine 24 makes the condition of the registration roller clutch 22 a disconnected condition. Thus, the registration roller 12f is halted. Further, when the pre-registration roller sensor 26 detects the second sheet of recording paper 200, and a predetermined amount of time has passed, the image formation engine 24 makes the condition of the registration roller clutch 22 a connected condition. Thus, the image formation engine 24 makes the registration roller 12f rotate. As a result, the recording paper 200 is transported towards the transfer roller 134a. Incidentally, the “predetermined amount of time” refers to the period of time from the moment when the recording paper 200 passes through the pre-registration roller sensor 26 to the moment at which a predetermined deflection is formed under a condition in which the recording paper 200 is pressed against the registration roller 12f.

After step S4, when the recording paper 200, transported by the registration roller 12f, is detected by the post-registration roller sensor 27, the image formation engine 24 adjusts the timing at which an image is formed on this recording paper 200 based on the timing at which the recording paper 200 is detected by the post-registration roller sensor 27 (step S5). In other words, similar to step S3 described above, the image formation engine 24 synchronizes the timing at which an image is formed on the recording paper 200 by making the laser scanning unit 136 create an electrostatic latent image on a peripheral surface of the photoreceptor drum 131 based on a timing at which the recording paper 200 is detected by the post-registration roller sensor 27.

After step S5, the image formation engine 24 determines whether or not an image formation has been completed (step S6). When the determination result of step S6 is “YES,” i.e., when the image formation is completed, the image formation engine 24 halts the operation. When the determination result of step S6 is “NO,” i.e., when the image formation is not completed, the image formation engine 24 returns to step S4, and once again performs steps S4 and S5.

As described above, according to the present embodiment, a timing at which an image is formed on a recording paper 200 is adjusted based on a timing at which a post-registration roller sensor 27 detects the recording paper 200. In this way, according to the present embodiment, a timing of image formation is synchronized based on a timing at which a recording paper 200, already transported from the registration roller 12f, is detected. As a result, it is possible to prevent the position of the image on the recording paper 200 from deviating due to a delay in the responsiveness of the registration roller clutch 22 of the registration roller 12f.

A preferable embodiment of the present invention has been described above. However, the present invention is not limited by the above embodiment. Components and configurations may be added, omitted, replaced, and other alterations may be made within the gist of the present invention. For example, the following variations are possible.

In the embodiment described above, the intermediate roller 12e and the registration roller 12f were controlled using the detection results of the pre-registration roller sensor 26. In addition, the timing of image formation was adjusted using the detection result of the post-registration roller sensor 27. However, the present invention is not limited by this configuration. For example, the detection results of the pre-registration roller sensor 26 and the post-registration roller sensor 27 may be used to detect a position at which a recording paper 200 is jammed.

In particular, when only the pre-registration roller sensor 26 is detecting the recording paper 200, the image formation engine 24 detects that a paper jam has occurred near the pre-registration roller sensor 26. When a detection has not been made by the pre-registration roller sensor 26 and the post-registration roller sensor 27, the image formation engine 24 determines that a paper jam has occurred at a location in front of the pre-registration roller sensor 26 or at a rear of the post-registration roller sensor 27 in a direction in which the recording paper 200 is transported. When a detection has been made by the pre-registration roller sensor 26 and the post-registration roller sensor 27, the image formation engine 24 determines that a paper jam has occurred between the pre-registration roller sensor 26 and the post-registration roller sensor 27. When a detection is made by the post-registration roller sensor 27, the image formation engine 24 determines that a paper jam has occurred near the post-registration roller sensor 27.

Furthermore, when the image formation engine 24 detects a paper jam as described above, and when only the pre-registration roller sensor 26 has detected the recording paper 200, the image formation engine 24 makes a display on the display unit 25 indicating that an operation may be conducted by an easy access from a frontal surface such as opening and closing the cassette. When a detection has not been made by the pre-registration roller sensor 26 and the post-registration roller sensor 27, the image formation engine 24 makes a display on the display unit 25 indicating that an operation may be performed by an access only from a rear side of the machine. When a detection has been made by the pre-registration roller sensor 26 and the post-registration roller sensor 27, the image formation engine 24 makes a display on the display unit 25 indicating that a desorption of a component or a processing unit such as a photoreceptor drum 131 and a development unit 133. When a detection is made by the post-registration roller sensor 27, the image formation engine 24 makes a display on the display unit 25 indicating that an operation may be made by an access only from a rear side of the machine if a sensor of the fixing unit has made the detection. When a detection is made by the post-registration roller sensor 27, the image formation engine 24 makes a display on the display unit 25 indicating that a desorption of a component or a processing unit such as a photoreceptor drum 131 and a development unit 133. Furthermore, in cases of a detection of other paper jams, the image formation engine 24 displays an operation according to a conventional manner. (for example, cases in which a recording paper 200 is not sent to a registration unit after the recording paper 200 is fed, and the like)

According to the embodiment described above, the intermediate roller 12e continued to be rotated when an image was formed on the second sheet and/or other subsequent sheets of recording paper 200. However, the present invention is not limited to this configuration. Regardless of whether the recording paper 200 is the first sheet, second sheet, or other subsequent sheets, the intermediate roller 12e may be halted after a predetermined amount of time has passed after the pre-registration roller sensor 26 detects the recording paper 200, and a deflection on the recording paper 200 may be adjusted.

In addition, the above image forming apparatus may be configured as follows: the image forming apparatus further includes: a pre-registration roller detection unit provided at an upper stream side of the registration roller in the direction in which the recording paper is transported, the pre-registration roller detection unit detecting the recording paper transported by the registration roller; and an intermediate roller provided at a further upstream side of the pre-registration roller detection unit, the intermediate roller transporting the recording paper to the registration roller. Here, the control unit halts the intermediate roller after a predetermined amount of time based on a timing at which the pre-registration roller detection unit detects the recording paper.

Here, a disconnected condition may be made when the intermediate roller is halted.

Further, the recording paper being transported may be a first sheet on which the image is formed.

In addition, the above image forming apparatus may be configured as follows: the control unit detects a position at which the recording paper is jammed based on a detection result of the pre-registration roller detection unit and a detection result of the post-registration roller detection unit.

In addition, the above image forming apparatus may be configured as follows: the image forming apparatus further includes an intermediate roller provided at an upper stream side of the registration roller in the direction in which the recording paper is transported, the intermediate roller transporting the recording paper to the registration roller; and a pre-registration roller detection unit provided between the intermediate roller and the registration roller, the pre-registration roller detecting the recording paper transported from the intermediate roller to the registration roller. Here, the control unit rotates the registration roller after a predetermined amount of time based on a timing at which the pre-registration roller detection unit detects the recording paper. Here, the control unit rotates the registration roller after a predetermined amount of time based on a timing at which the pre-registration roller detection unit detects the recording paper.

In addition, the above image forming apparatus may be configured as follows: the recording paper being transported is a second sheet on which the image is formed or a subsequent sheet on which the image is formed.

In addition, the above image forming method may be configured as follows: the image forming method further includes a pre-registration roller detection step detecting the recording paper, transported by the registration roller, at an upper stream side of the registration roller in a direction in which the recording paper is transported; and a halting step halting an intermediate roller after a predetermined amount of time after the recording paper is detected in the pre-registration roller detection step. Here, the intermediate roller is located at a position at a further upper stream side compared to a position at which the recording paper was detected in the pre-registration roller detection step. The intermediate roller transports the recording paper to the registration roller.

The present invention is not limited by the embodiments described above.

What is claimed is:

1. An image forming apparatus comprising:
an image forming unit forming an image on a recording paper;
a registration roller transporting the recording paper to the image forming unit;
a post-registration roller detection unit provided at a down stream side of the registration roller in a direction in which the recording paper is transported, the post-registration roller detection unit detecting the recording paper transported by the registration roller; and
a control unit adjusting a timing in which the image forming unit forms the image on the recording paper based on a timing at which the post-registration roller detection unit detects the recording paper.

2. The image forming apparatus according to claim 1, further comprising:
a pre-registration roller detection unit provided at an upper stream side of the registration roller in the direction in which the recording paper is transported, the pre-registration roller detection unit detecting the recording paper transported by the registration roller; and
an intermediate roller provided at a further upper stream side of the pre-registration roller detection unit, the intermediate roller transporting the recording paper to the registration roller, wherein
the control unit halts the intermediate roller after a predetermined amount of time based on a timing at which the pre-registration roller detection unit detects the recording paper.

3. The image forming apparatus according to claim 2, wherein the intermediate roller is disconnected, when the intermediate roller is halted.

4. The image forming apparatus according to claim 2, wherein the recording paper being transported is a first sheet on which the image is formed.

5. The image forming apparatus according to claim 2, wherein the control unit detects a position at which the recording paper is jammed based on a detection result of the pre-registration roller detection unit and a detection result of the post-registration roller detection unit.

6. The image forming apparatus according to claim 1, further comprising:
an intermediate roller provided at an upper stream side of the registration roller in the direction in which the recording paper is transported, the intermediate roller transporting the recording paper to the registration roller; and
a pre-registration roller detection unit provided between the intermediate roller and the registration roller, the pre-registration roller detection unit detecting the recording paper transported from the intermediate roller to the registration roller, wherein
the control unit rotates the registration roller after a predetermined amount of time based on a timing at which the pre-registration roller detection unit detects the recording paper.

7. The image forming apparatus according to claim 6, wherein the recording paper being transported is a second sheet on which the image is formed or a subsequent sheet on which the image is formed.

8. An image forming method comprising:
a registration step transporting a recording paper and registering with a registration roller;
a post-registration roller detection step detecting the recording paper, transported by the registration roller, at a down stream side of the registration roller in a direction in which the recording paper is transported; and
a control step adjusting a timing at which an image is formed on the recording paper based on a timing at which the recording paper is detected in the post-registration roller detection step.

9. The image forming method according to claim 8, further comprising:
a pre-registration roller detection step detecting the recording paper, transported to the registration roller, at an upper stream side of the registration roller in a direction in which the recording paper is transported; and
a halting step halting an intermediate roller after a predetermined amount of time after the recording paper is detected in the pre-registration roller detection step, the intermediate roller being located at a position at a further upper stream side compared to a position at which the recording paper was detected in the pre-registration roller detection step, the intermediate roller transporting the recording paper to the registration roller.
